(19) United States
(12) Patent Application Publication
(10) Pub. No.: US 2013/0312116 A1
(43) Pub. Date: Nov. 21, 2013

(54) SOCIAL NETWORK SYSTEM FOR RESOURCE SHARING, AND METHOD FOR THE ESTABLISHMENT AND MAINTENANCE OF SAME

(71) Applicant: Jong-Tae J. Park, Daegu (KR)

(72) Inventor: Jong-Tae J. Park, Daegu (KR)

(73) Assignee: Kyungpook National University Industry-Academic Cooperation Foundation, Daegu (KR)

(21) Appl. No.: 13/992,478

(22) PCT Filed: Dec. 8, 2010
(86) PCT No.: PCT/KR2010/008759

§ 371 Date: Jul. 22, 2013

(30) Foreign Application Priority Data
Dec. 7, 2010 (KR) 10-2010-0124259

(51) Int. Cl. H04L 29/06

(52) U.S. Cl. CPC H04L 63/101
USPC 726/28

(57) ABSTRACT

A social network system for resource sharing, and a method for the establishment and maintenance of same are provided. According to the present invention, the social network system for resource sharing includes: a plurality of entities constituting a social network; a sharing resource owned by at least one entity of the plurality of entities; a trust strength for representing the degree of trust in a relationship, which is formed in a unilateral or bilateral way between each of the entities in order to share the resource; and a communication protocol for sharing the resource among the plurality of entities. The trust strength is classified into a plurality of classes. Each of the entities grants a different access right to another entity according to each of the classes.

### TECHNICAL FIELD

The present invention relates to a social network system for sharing resources and a method of building and maintaining the social network system, and more particularly, to a social network system for differentially sharing resources according to a trust level between members, and a method of building and maintaining the social network system.

### BACKGROUND ART

More and more people are using a social network service (SNS) while moving as mobile devices having a wireless network function are widely used by using third generation (3G) mobile communication technology or Wi-Fi (IEEE802.11) that supports a high bandwidth of 802.11b, g, n standard as in a smartphone. Most of social network services that have been developed until now provide a method of forming a relationship between fellow students, friends and people of certain groups, sharing personal information and extending a social relationship between people using a list of friends.

The social network services may be divided into various types, but a major type is a service that classifies people such as friends and fellow students. Such a social network service generally allows a user to contact friends or fellow students through a personal blog. Furthermore, photos or music may be shared based on trust formed between people. Some representative examples of social network services in Korea are Cyworld, and Naver me2DAY which is a social network service of a micro blog type, and some representative examples of social network services in USA are Facebook, Myspace, and Twitter. Furthermore, Skyrock is widely used in Europe. Likewise, various social network services are being provided worldwide.

Most of social network service systems such as Facebook having more than 500 million members worldwide as of 2010 and Cyworld which is a representative social network service in Korea provide setting a relationship between people, extending a relationship between people using friends of friends, and sharing of a personal profile according to trust. Myspace in USA allows sharing of music, video and games between friends through the SNS.

However, the social network service according to a prior art provides a function of sharing personal information according to the trust between members, but does not provide a method of differentially sharing content and safely sharing real-world resources according to the trust level. For example, when building a social network service in a company, an electronic key that allows entrance to certain places in the company building may be differentially provided to a smartphone according to the trust grade of an employee. Furthermore, when sharing a wireless local area network (LAN) sharing device between members of a portable social network service, a credential sharing rights for accessing the sharing device may be differentiated according to the trust grade between the members.

When sharing real-world resources such as a building key, a wireless LAN sharing device and a credential, differentiated access rights sharing service according to the trust level between users is essential unlike when sharing a method of sharing network resources in Internet such as a MP3 music file and a YouTube video clip.

However, the social network service according to the prior art does not provide a method and system for sharing safe access rights for network or real-world resources between members on the move. When considering the rapid increase of the members of social network services, a method and system for safely sharing various resources through a social network service is essential.

### DISCLOSURE OF THE INVENTION

### Technical Problem

The present invention provides a social network system for safely sharing network and real-world resources by differentiating access rights for the resources according to a trust level, and a method of building and maintaining the social network system.

The present invention also provides a social network system for sharing resources between entities having indirect trust relationship based on a trust level, and a method of building and maintaining the social network system.

The present invention also provides a social network system that spends fewer resources in maintaining the system because a trust relation list may be quickly formed or deleted when a new entity enters or the existing entity leaves an already formed social network, and a method of building and maintaining the social network system.

The objects of the present invention are not limited to the above-mentioned objects, and other objects which are not mentioned above may be understood to those skilled in the art from the disclosure below.

### Technical Solution

According to an aspect of the present invention, a social network system for sharing resources includes: a plurality of entities that form a social network; shared resources owned by one or more entities among the plurality of entities; a trust level indicating a level of a trust relation that is unilaterally or mutually formed between each of the entities to share the shared resources; and a communication protocol for sharing the shared resources between the plurality of entities, wherein the trust level is classified into a plurality of classes, and wherein each of the entities grants a differential access right to the shared resources owned by the entity to another entity according to each of the classes.

According to another aspect of the present invention, a social network system for sharing resources includes: a plurality of entities that form a social network; and a trust level indicating a level of a trust relation that is unilaterally or mutually formed between each of the entities, wherein the trust level is classified into n classes including class 1 to class n, and the n is a natural number, and wherein, when one entity has a trust level corresponding to the class n with another entity, the one entity forms a trust relation with further another entity that has an indirect nth level trust relation with the one entity via the another entity.

According to another aspect of the present invention, a social network system for sharing resources includes: a plurality of entities that form a social network; shared resources owned by one or more entities among the plurality of entities; a trust level indicating a level of a trust relation that is unilaterally or mutually formed between each of the entities to share the shared resources; and a communication protocol for sharing the shared resources between the plurality of entities, wherein the trust level is classified into n classes including class 1 to class n and the n is a natural number, and wherein, when one entity has a trust level corresponding to the class n with another entity, the one entity forms a trust relation with further another entity that has an indirect nth level trust relation with the one entity via the another entity.

According to another aspect of the present invention, a method of building and maintaining a social network system for sharing resources includes: forming a trust relation between a first entity and a second entity which is one of a plurality of entities at a trust level of class n; and adding a plurality of remaining entities except the plurality of entities having an indirect (n+1)th trust relation with the first entity via the second entity to the list of trust relation of the first entity, wherein the n is a natural number.

According to another aspect of the present invention, a method of building and maintaining a social network system for sharing resources includes: entering a social network by a new entity; forming a trust relation between the new entity and a first entity which is one of a plurality of existing entities at a trust level of class n; granting, by the new entity, an access right to shared resources of the new entity to the first entity; and granting, by the new entity, an access right to the shared resources of the new entity to a second entity that has an indirect trust relation of an n or less level with the new entity via the first entity, wherein the n is a natural number.

According to another aspect of the present invention, a method of building and maintaining a social network system for sharing resources includes: deleting a trust relation granted to an entity that exists in a list of trust relation of one of a plurality of entities that form a social network; requesting deletion of the trust relation to the entity that has the deleted trust relation; and deleting the trust relation granted to the one entity by the entity that has received the request of deletion of the trust relation.

Other specific points of the embodiments are included in the detailed description of the invention and attached drawings.

### Advantageous Effects

According to a method of building and maintaining a social network system for sharing resources of the present invention, access rights for network contents and real-world resources may be differentiated according to trust levels and be safely shared between entities that build the social network.

Furthermore, according to the present invention, resources may be shared between entities which have an indirect trust relation based on the trust level, and when a new entity enters the already formed social network or the existing entity leaves the social network, the trust relation list may be quickly formed or deleted, and thus less resources may be spent in maintaining the system.

### BRIEF DESCRIPTION OF THE DRAWINGS

FIG. 1 is a diagram schematically illustrating a social network system for sharing resources according to an embodiment of the present invention;

FIG. 2 is a diagram illustrating a trust level according to an embodiment of the present invention;

FIG. 3 is a diagram illustrating a trust relation list of a social network system for sharing resources according to an embodiment of the present invention; and

FIG. 4 is a flowchart illustrating a method of building and maintaining a social network system for sharing resources according to an embodiment of the present invention.

### BEST MODE FOR CARRYING OUT THE INVENTION

Hereinafter, embodiments of the present invention will be described with reference to the accompanying drawings.

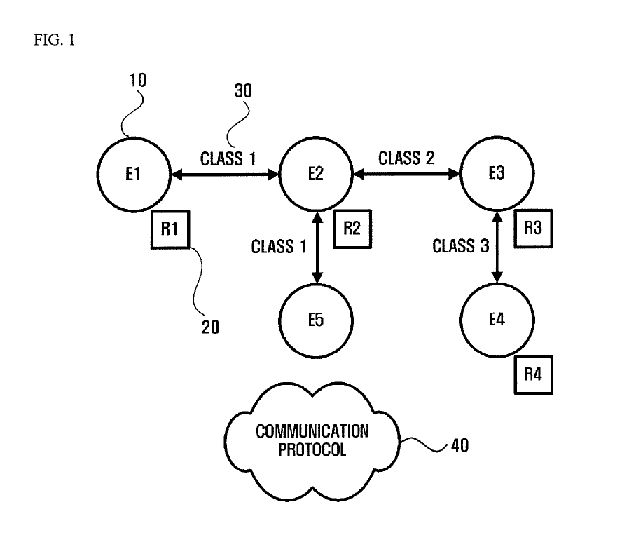

FIG. 1 is a diagram schematically illustrating a social network system for sharing resources according to an embodiment of the present invention. The social network system includes a plurality of entities 10 that form a social network, shared resources 20 owned by one or more entities of the plurality of entities 10, a trust level 30 indicating the trust level that is unilaterally or mutually formed between the respective entities 10 in order to share the shared resources 20, and a communication protocol 40 for sharing the shared resources 20 between the plurality of entities 10. Here, the trust level 30 is classified as a plurality of classes, and each entity 10 grants differential access rights to the shared resource 20 owned by the entity to different entities according to each of the classes.

The entity 10 is each unit that forms a social network, and may refer to a member of the social network in the real world. In FIG. 1, first entity E1 to fifth entity E5 are illustrated.

For example, in a social network formed in a department of a company, each individual of the department is an entity 10. Furthermore, in the network, each user that uses a social network service (SNS) may be an entity 10, and the entity 10 may also refer to each computer terminal that constitutes one network, or a computer program or process that is executed in an online network.

Likewise, a plurality of entities 10 may build a social network by forming trust relation, and the trust relation may vary depending on the type or characteristic of the social network. That is, as an example of the trust relation, in the case of a social network of a simple purpose of friendship, a plurality of entities 10 may form direct or indirect trust relation such as a friend (F), a friend of friend (FOF), and a friend of friend of friend (FOFOF), and in the case of a social network formed between employees of a company, a plurality of entities 10 may form trust relation that reflects horizontal and vertical organization relation.

Assuming the example of FIG. 1 as a social network of a purpose of friendship, the first entity E1 forms trust relation of a friend F with a second entity E2, and the first entity E1 and a third entity E3 form trust relation of a friend of friend (FOF) via the second entity E2. Likewise, the first entity E1 and a fourth entity E4 form a trust relation of a friend of friend of friend (FOFOF).

Each of the plurality of entities that form a social network may share shared resources 20. In the example of FIG. 1, the shared resources are displayed as R1 to R4. All entities 10 may have the shared resources 20, and only some of the plurality of entities 10 may have the shared resources 20. In the illustrated example, all of the first entity E1 to the fourth entity E4 share the shared resources R1 to R4, respectively, but the fifth entity E5 does not share the shared resources 20, and thus the shared resources 20 to be provided to another entity do not exist.

In the social network system for sharing resources according to an embodiment of the present invention, entities 10 that have been connected by indirect trust relation as well as entities 10 having direct trust relation may have an access to mutual shared resources 20. However, access to the shared resources 20 between the entities 10 connected by indirect trust relation should be done according to a strict restriction, and thus the access to the shared resources 20 between the entities 20 connected by indirect trust relation is restricted according to the trust level 30.

The shared resources 20 that may be shared by respective entities 10 may include a content composed of one or more of an audio content, a video content and a text content. The content may be an electric content executed in a computing device. That is, Some examples of the shared resources are an audio content such as an MP3 and WAV, a video content such as AVI, MKV, MOV and MPEG, and a text content such as TXT, DOC, PPT, HWP and HTM.

Furthermore, the shared resources 20 according to an embodiment of the present invention may include real-world resources composed of one or more of an entrance electric key, an access point password, a password for entrance to a restricted area, a password for operation of a machine or device, and a password for access to restricted equipment.

That is, unlike the configuration of a prior art, an electronic key for entrance to a company or a region which is allowed to limited people of a certain place as well as content that may be generally shared may be shared in an electronic authentication certificate or public key form, so that entities 10 of a certain range may receive the right and use the key. Furthermore, the password for access to the access point that provides a wireless network is shared between entities 10, and thus when belonging to an area within a valid distance of the access point, the entities 10 may be allowed to use the wireless network of the access point.

Furthermore, the entrance password of the restricted area or the operation password of a certain machine or device may correspond to the shared resources 20 shared between entities 10. The above-described shared resources 20 are merely an example, and may include all forms of resources that may be shared within the range of the present invention.

The shared resources 20 may be shared through a communication protocol 40. Some examples of the communication protocol 40 may include one or more of a cloud computing, a TCP/IP, HTTP and FTP. Each entity 10 may have an access to the shared resources of another entity with which trust relation has been formed using the communication protocol 40. For example, when the shared resources 20 are the access point password, the entity 10 may obtain the password and approach the valid area of the access point so that the entity 10 may use the non-public wireless network.

The trust level 30 indicates the level of trust that is unilaterally or mutually formed between respective entities 10 to share the shared resources 20. The trust level 30 may be determined by the trust class and trust distance. That is, the trust level 30 is a numerical value that is obtained after overall consideration of the trust level between respective entities 10.

If the trust level 30 is high, the mutual trust relation between the entities 10 may be formed and indirect trust relation may also be formed with another entity 10 that forms the trust relation with each entity 10, thereby providing shared resources 20.

The trust distance refers to a distance between entities 10 in a social network. For example, as illustrated in FIG. 1, assuming that the trust distance between the second entity E2 and each of the first entity, E1, the third entity E3 and the fifth entity E5 is 1, the trust distance between the second entity E2 and the fourth entity E4 is 2. As the trust distance increases, the relation becomes indirect, and thus the trust level 30 is reduced.

A trust class refers to weight that may be given to each entity 10. That is, the overall trust level 30 may be increased by granting a high trust class to an entity 10 that may be especially trusted even though the trust distance is large.

As a conclusion, the trust level 30 is proportional to the trust class and is inversely proportional to the trust distance, and the trust level 30 may be defined by a function of a trust class and a trust distance.

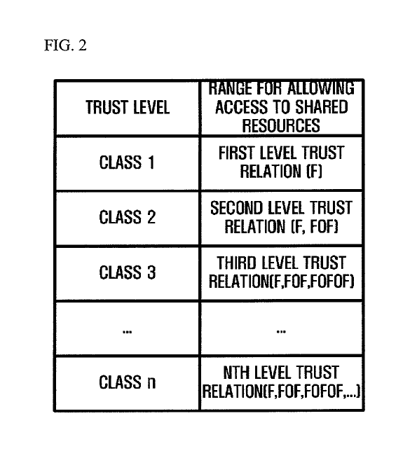

FIG. 2 is a diagram illustrating a trust level according to an embodiment of the present invention, and shows an access right as shared resources 20 according to the trust level 30. As described above, the access to shared resources 20 between respective entities 10 may be restricted by the trust level 30 according to an embodiment of the present invention.

For example, as illustrated in FIG. 2, it is assumed that the trust class is 1 without special weight, the trust distance is proportional to the trust level 30, and the trust level 30 is classified into n classes (n is a natural number). In FIG. 2, class 1 allows access to the shared resources 20 up to a friend (F) which whom direct trust relation is formed, allows class 2 up to a friend of friend (FOF), and allows class 3 up to a friend of friend of friend (FOFOF). That is, as the number of the class increases, access to the shared resources 20 is allow to more entities 10.

In an example of FIG. 1, the first entity E1 and the second entity E2 mutually have the trust level 30 of class 1, and thus the access to the shared resources R1 and R2 is allowed only between the first and second entities E1 and E2 that have direct trust relation of friend (F). That is, the first entity E1 may have an access to the shared resources R2 of the second entity E2, and the second entity E2 may have an access to the shared resources R1 of the first entity E1.

Furthermore, the third entity E3 and the second entity E2 have a trust level 30 of class 2, and thus the third entity E3 allows an access to the shared resources R3 to the second entity E2 that has direct trust relation with the third entity E3 and the first entity E1 which has the friend of friend (FOF) relation.

Likewise, the fourth entity E4 and the third entity E3 have the trust level 30 of class 3, and thus the fourth entity E4 allows an access to the shared resources R4 to the third entity E3 that has direct trust relation with the fourth entity E4, the second entity E2 has a friend of friend (FOF) relation and the first entity E1 that has a friend of friend of friend (FOFOF) relation.

Hence, the first entity E1 may have an access to all the resources R2, R3 and R4 of the second entity E2, the third entity E3 and the fourth entity E4, but the third and fourth entities E3 and E4 cannot have an access to the shared resources R1 of the first entity. Likewise, differential access to shared resources is possible as a different trust level 30 is given in the mutual relation, and an access to the shared resources 20 of an undesired entity 10 may be prevented, and thus security may be maintained and privacy may be effectively protected.

If the relation between the first entity E1 and the second entity E2 is defined as direct trust relation (first level trust relation; F), the relation between the first entity E1 and the third entity E3 may be defined as indirect trust relation (second level trust relation; FOF), and the first entity E1 and the fourth entity E4 may be defined as the third trust relation (FOFOF).

Hence, as illustrated in FIG. 2, when one entity 10 has a trust level 30 of class n, an access to the shared resources 20 of the entity may be given to other entities having nth level trust relation as well as entities having first level trust relation (direct trust relation).

When one entity 10 has trust level 30 of class n, it is obvious that an access to shared resources of the entity 10 may be allowed to entities having (n−1)th trust relation as well as entities having nth trust relation.

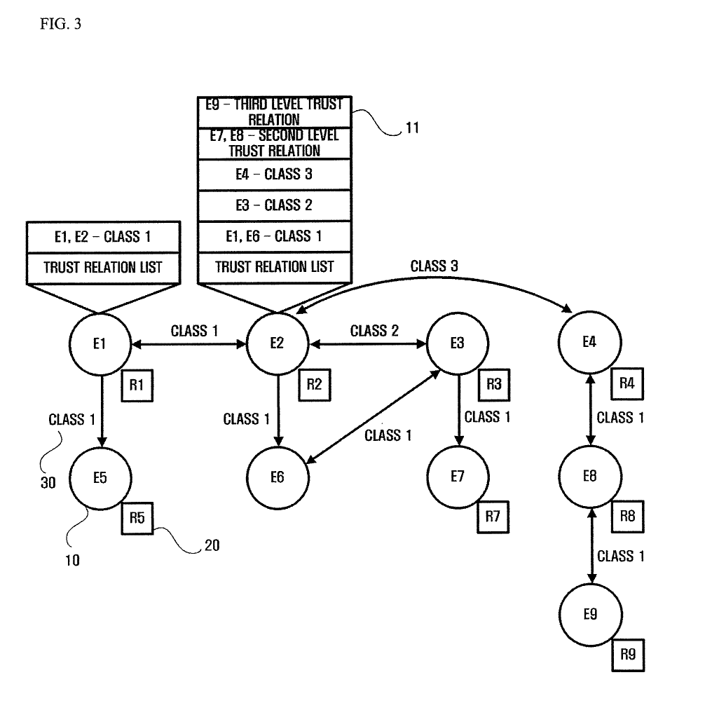

FIG. 3 is a diagram illustrating a trust relation list of a social network system for sharing resources according to an embodiment of the present invention, and a social network system according to another embodiment of the present invention includes a plurality entities 10 that form a social network, a trust level 30 indicating the level of trust that is unilaterally or mutually formed between respective entities 10. Here, the trust level 30 is classified into n classes including class 1 to class n, in which “n” is a natural number. When one entity and another entity have trust relation of claim n, the one entity grants trust relation to another entity having trust relation that is directly connected by nth level relation with the one entity via the another entity.

As described above, when the trust level 30 of one entity 10 is class n, a certain network may be maintained with other entities having indirect second to nth trust relation as well as other entities having direct first trust relation.

The social network system for sharing resources according to another embodiment of the present invention may include a plurality of entities 10 that form a social network, shared resources that are shared by one or more entities among the plurality of entities, a trust level indicting the level of trust that is unilaterally or mutually formed between respective entities, and a communication protocol 40 for sharing the shared resources between the plurality of entities. Here, the trust level is classified into n classes including class 1 to class n, and the “n” is a natural number. Furthermore, when one entity has a trust level 30 corresponding to class n with another entity, the one entity provides the shared resources 20 to another entity having indirect n level trust relation with the one entity via the another entity.

As described above, when the trust level 30 of one entity 10 is class n, the access to the shared resources 20 may be allowed to other entities having second to nth trust relation as well as other entities having direct first trust relation.

In the above described embodiments, each entity 10 may include a trust relation list 11 including direct or indirect trust relation information. The trust relation list 11 may include list information of other entities that form first to nth level direct or indirect trust relation, and information on the trust level 30 with entities having first level trust relation among the listed entities.

As illustrated in FIG. 3, the first entity E1 forms a trust level 30 of class 1 with second and fifth entities E2 and E5, and thus entities that form indirect trust relation do not exist in addition to two entities corresponding to the first trust relation. In such a case, the trust relation list L1 of the first entity E1 includes list information of second and fifth entities E2 and E5 and trust level 30 information with the second and fifth entities E2 and E5.

In contrast, in the case of the second entity E2, first level trust relation F is formed with the first, third, fourth, and sixth entities E1, E3, E4 and E6, the second level trust relation FOF is formed with the seventh and eighth entities E7 and E8, and a third level trust relation FOFOF is formed with the ninth entity E9.

In the illustrated example, the second entity E2 and the fifth entity E5 do not have any trust relation. That is, it seems that the fifth entity E5 is connected to the second entity E2 via the first entity E1, but the second entity E2 and the first entity E1 have the trust level of class 1, and thus the fifth entity E5 does not receive an access right to the shared resources R1 of the second entity E2, and a trust relation is not formed. As such, the access of the shared resources 20 of the fifth entity E5 may be prevented.

Likewise, according to a social network system for sharing resources according to embodiments of the present invention, the access rights to the network contents and real-world resources are differentiated according to the trust level 30, and thus the access rights may be safely shared between entities 10 that build a social network. In particular, the resources may be set to be shared between entities having indirect trust relation based on the trust level 30 as described above.

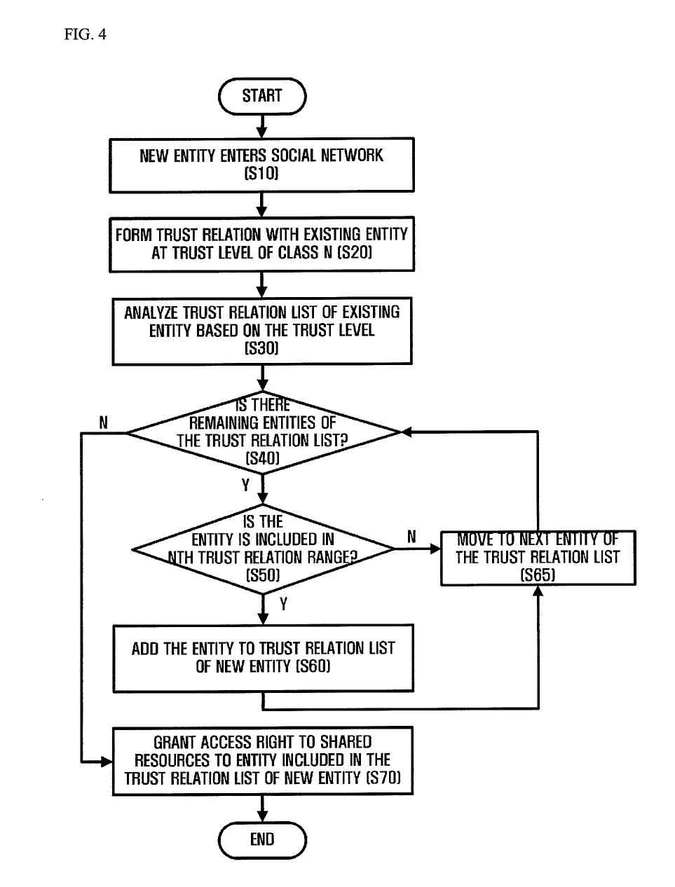

Thereafter, FIG. 4 is a flowchart illustrating a method of building and maintaining a social network system for sharing resources according to an embodiment of the present invention. The method of building and maintaining a social network system for sharing resources according to an embodiment of the present invention may include an operation (S10) where a new entity enters a social network, an operation (S20) where the new entity forms trust relation at a trust level of class n with a first entity which is one of a plurality of the existing entities, and an operation (S50) where a plurality of existing entities except the plurality of existing entities having indirect trust relation of (n+1)th or larger level relation with the new entity via the first entity are added to a trust relation list of the new entity. Here, n is a natural number.

When a new entity E_NEW enters an already built social network (S10), the new entity E_NEW forms trust relation with one or more entities 10 among the existing entities 10. The trust relation with one entity 10 may be formed at one time, but it is also possible to form trust relation with a plurality of entities 10 at one time.

As described above, if a new entity E_NEW forms trust relation at a trust level of class n with one (E_OLD) of the existing entities 10, an access to the shared resources 20 of the new entity E_NEW may be allowed to all entities 10 that form nth level trust relation with the new entity E_NEW via the existing entity E_OLD.

To this end, the trust relation list 11 of the existing entity E_OLD is requested and received, and the trust relation list 11 is analyzed (S30). The trust relation list 11 includes the list of all entities 10 that form trust relation with the existing entity E_OLD, and thus it is determined whether the entity corresponds to a range of the nth trust relation while circulating for each entity included in the trust relation list 11 (S40 and S50). The determination is made based on the new entity E_NEW, and thus only the entities corresponding to the (n−1)th trust relation are included in the range in the trust relation list of the existing entity E_OLD.

For example, if a new entity E_NEW forms trust level of class 3 with the existing entity E_OLD, the shared resources 20 are opened up to the entity that belongs to the range of the third level trust relation (FOFOF) based on the new entity E_NEW, and thus an access right to the shared resources 20 of the new entity E_NEW is granted to entities that belong to the range of the second level trust relation (FOF) of the existing entity E_OLD.

Likewise, the entity included in the range of the nth level trust relation of the new entity E_NEW is added to the trust relation list of the new entity E_NEW (S60).

If the analysis and addition process for all entities included in the trust relation list of the existing entity E_OLD is terminated, the access right of the shared resources 20 is granted to the subject entity based on the trust relation list of the completed new entity E_NEW (S70). It is obvious that the existing entity E_OLD that forms first level direct trust relation with the new entity E_NEW is included in the trust relation list of the completed new entity E_NEW.

The case where a new entity has entered the social network has been described above, but the present invention is not limited thereto, and the present invention may also be applied to the case where the existing entity forms a trust relation with the new entity at the trust level of class n.

That is, the method of building and maintaining the social network system for sharing resources according to an embodiment of the present invention includes an operation where the first entity forms trust relation of the trust level of class n with the second entity which is one of a plurality of entities, and an operation where a plurality of entities except the plurality of entities having the indirect (n+1)th or larger trust relation with the first entity via the second entity are added to the trust relation list of the first entity, in which “n” is a natural number.

Likewise, the method may be applied even when the existing entity as well as a newly-entered entity forms a trust relation with another entity.

Thereafter, a method of building and maintaining a social network system for sharing resources according to another embodiment of the present invention includes an operation of entering a social network by a new entity E_NEW (S10), an operation of forming a trust relation between the new entity N_NEW and a first entity E_OLD which is one of a plurality of existing entities at a trust level of class n, an operation of granting, by the new entity E_NEW, an access right to shared resources of the new entity E_NEW to the first entity E_OLD, and an operation granting, by the new entity E_NEW, an access right to the shared resources of the new entity E_NEW to a second entity E_OLD_{—}2 that has an indirect trust relation of an n or less level with the new entity E_NEW via the first entity E_OLD, where the n is a natural number.

Unlike the above embodiment, the entity E_NEW that has newly entered the social network may grant an access right to the shared resources of the new entity E_NEW to the first entity E_OLD that forms a first level trust relation.

Furthermore, an operation of adding a new entity E_NEW to the list of trust relation received from the first entity E_OLD may be included.

The process of adding the new entity E_NEW to the list trust relation of the first entity E_OLD may be performed simultaneously in the process of forming a trust level of class n between the new entity E_NEW and the first entity E_OLD.

Furthermore, a method of building and maintaining a social network system for sharing resources according to another embodiment of the present invention includes an operation of deleting a trust relation granted to an entity that exists in a list of trust relation of one of a plurality of entities that form a social network, an operation of requesting deletion of the trust relation to the entity that has the deleted trust relation, and an operation of deleting the trust relation granted to the one entity by the entity that has received the request of deletion of the trust relation.

For example, the already formed trust relation may be damaged or broken by various reasons. Hence, when such a trust relation disappears, a series of processes of deleting a trust relation are performed to be reflected in the social network system for sharing resources. Furthermore, even when one or more entities withdraw from the social network, the process of collecting or scrapping the trust relation and shared resources opened to the public may be performed.

That is, one entity includes the list of trust relation, and the trust relation granted to each other is deleted by deleting the trust relation granted to the entity that exists in the list, and requesting the deletion of the trust relation granted to the one entity to the entity that has the deleted trust relation.

The operation of collecting or scrapping the remaining shared resourced provided by the one entity along with the deletion of the trust relation may be further included.

That is, for example, a person who leaves a company should not have an access to a restricted area of the company, and thus the password key issued to the smartphone, etc. of the person should be scrapped so that the person may not be able to use the password key.

Furthermore, when an entity which is a member of the existing social network withdraws from the social network, the operation of deleting the trust relation may include deleting trust relation granted to all entities that exist in the list of trust relation. That is, the trust relation has no meaning to the entities that withdraw from the social network, and thus all trust relations are deleted, and the opponent entity may also delete the trust relation granted to the withdrawing entity.

All trust relations are deleted and shared resources provided to each other are collected or scrapped, and then the entity may withdraw from the social network.

As described above, according to a method of building and maintaining a social network system for sharing resources according to the embodiments of the present invention, resources may be shared between entities which have an indirect trust relation based on the trust level, and when a new entity enters the already formed social network or the existing entity leaves the social network, the trust relation list may be quickly formed or deleted, and thus less resources may be spent in maintaining the system and a social network system having a high security level may be provided.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A social network system for sharing resources, the social network system comprising:
a plurality of entities that form a social network;
shared resources owned by one or more entities among the plurality of entities;
a trust level indicating a level of a trust relation that is unilaterally or mutually formed between each of the entities to share the shared resources; and
a communication protocol for sharing the shared resources between the plurality of entities,
wherein the trust level is classified into a plurality of classes, and
wherein each of the entities grants a differential access right to the shared resources owned by the entity to another entity according to each of the classes.

2. The social network system of claim 1, wherein each of the entities forms a trust relation with one or more other entities.

3. The social network system of claim 1, wherein the differential access right owned by each of the entities includes an access right to share resources of a first entity that forms a trust relation with each of the entities and shared resources of a second entity that forms a trust relation with the first entity.

4. The social network system of claim 3, wherein the differential access right includes an access right to shared resources of a third entity that forms a trust relation with the second entity.

5. The social network system of claim 1, wherein the differential access right further includes an access right to shared resources of a (n+1)^{th} entity that forms a trust relation with the n^{th} entity,
wherein the n is a natural number and is a same number as a number of the plurality of classes.

6. The social network system of claim 1, wherein the shared resources include real-world resources composed of one or more of an electric key for entrance, an access point password, a password for entering a restricted area, a password for operating a predetermined machine or device, and a password for having an access to restricted equipment.

7. A social network system for sharing resources, the social network system comprising:
a plurality of entities that form a social network; and
a trust level indicating a level of a trust relation that is unilaterally or mutually formed between each of the entities,
wherein the trust level is classified into n classes including class 1 to class n, and the n is a natural number, and
wherein, when one entity has a trust level corresponding to the class n with another entity, the one entity forms a trust relation with further another entity that has an indirect nth level trust relation with the one entity via the another entity.

8. The social network system of claim 7, wherein each of the entities includes a list of trust relation that is formed with one or more other entities,
wherein the list of trust relation includes a list of other entities that form the trust relation, and respective trust levels of the other entities.

9. A social network system for sharing resources, the social network system comprising:
a plurality of entities that form a social network;
shared resources owned by one or more entities among the plurality of entities;
a trust level indicating a level of a trust relation that is unilaterally or mutually formed between each of the entities to share the shared resources; and
a communication protocol for sharing the shared resources between the plurality of entities,
wherein the trust level is classified into n classes including class 1 to class n and the n is a natural number, and
wherein, when one entity has a trust level corresponding to the class n with another entity, the one entity forms a trust relation with further another entity that has an indirect n^{th} level trust relation with the one entity via the another entity.

10. The social network system of claim 9, wherein the shared resources include real-world resources composed of one or more of an electric key for entrance, an access point password, a password for entering a restricted area, a password for operating a predetermined machine or device, and a password for having an access to restricted equipment.

11. The social network system of claim 9, wherein, when the trust relation is unilaterally formed, a first entity which receives the trust relation approaches the shared resources owned by a second entity which has given the trust relation, and the second entity cannot approach the shared resources owned by the first entity.

12. The social network system of claim 9, wherein each of the entities includes a list of trust relation that has been formed with another entity, wherein the list of trust relation includes a list of other entities that form the trust relation and respective trust levels of the other entities.

13. A method of building and maintaining a social network system for sharing resources, the method comprising:
forming a trust relation between a first entity and a second entity which is one of a plurality of entities at a trust level of class n; and
adding a plurality of remaining entities except the plurality of entities having an indirect (n+1)^{th} trust relation with the first entity via the second entity to the list of trust relation of the first entity,
wherein the n is a natural number.

14. The method of claim 13, further comprising:
granting an access right to the shared resources of the first entity to the second entity.

15. The method of claim 13, further comprising:
granting, by the first entity, an access right to the shared resources of the first entity to a third entity that has an indirect trust relation of an n or less level with the first entity via the second entity.

16. A method of building and maintaining a social network system for sharing resources, the method comprising:
entering a social network by a new entity;
forming a trust relation between the new entity and a first entity which is one of a plurality of existing entities at a trust level of class n;
granting, by the new entity, an access right to shared resources of the new entity to the first entity; and
granting, by the new entity, an access right to the shared resources of the new entity to a second entity that has an indirect trust relation of an n or less level with the new entity via the first entity,
wherein the n is a natural number.

17. The method of claim 16, after forming the trust relation, further comprising:
receiving a list of trust relation from the first entity; and
searching for a plurality of existing entities having a trust relation with the first entity based on the list of trust relation.

18. The method of claim 17, after searching for the plurality of existing entities, further comprising:
adding a plurality of existing entities except the plurality of existing entities having an indirect (n+1)^{th} trust relation with the new entity via the first entity to the list of trust relation of the new entity.

19. The method of claim 17, further comprising:
adding the new entity itself to the list of trust relation.

20. A method of building and maintaining a social network system for sharing resources, the method comprising:
deleting a trust relation granted to an entity that exists in a list of trust relation of one of a plurality of entities that form a social network;
requesting deletion of the trust relation to the entity that has the deleted trust relation; and
deleting the trust relation granted to the one entity by the entity that has received the request of deletion of the trust relation.

21. The method of claim 20, wherein the deleting of the trust relation includes deleting a trust relation granted to all entities that exist in the list of trust relation.

22. The method of claim 21, further comprising:
withdrawing, by the one entity, from the social network.

23. The method of claim 20, further comprising:
collecting or scrapping the remaining shared resources provided by the one entity.
